(19) United States
(12) Patent Application Publication
(10) Pub. No.: US 2025/0034015 A1
(43) Pub. Date: Jan. 30, 2025

(54) CONTINUOUS FLOW CYCLIC-OPERATING WASTEWATER TREATMENT PLANT AND PROCESS FOR GROWING, SELECTING AND MAINTAINING AEROBIC GRANULAR SLUDGE WHILE TREATING WASTEWATER

(71) Applicant: WATERLEAU GROUP NV, Wespelaar (BE)

(72) Inventors: Stijn WYFFELS, Herent (BE); Hannah STES, Schelle (BE); Ronny GERARDS, Attenhoven (BE)

(73) Assignee: WATERLEAU GROUP NV, Wespelaar (BE)

(21) Appl. No.: 18/713,644

(22) PCT Filed: Nov. 25, 2022
(86) PCT No.: PCT/EP2022/083320

§ 371 Date: May 25, 2024

(30) Foreign Application Priority Data
Nov. 26, 2021 (BE) BE2021/5923

(51) Int. Cl. C02F 3/30; C02F 3/00; C02F 11/04

(52) U.S. Cl. CPC C02F 3/30; C02F 3/006; C02F 11/04

(57) ABSTRACT

The invention relates to a process and a water treatment plant involving a continuous flow cyclic-operating water treatment plant (1) comprising a series of at least three compartments, comprising sludge, in hydraulic connection (2AB, 2AC, 2BC) with each other, wherein growing, selecting and/or maintaining aerobic granular sludge while treating water. To achieve this goal, a sequence of feast and famine conditions has been engineered. An influent is continuously receiving (4) into a first compartment of the series of at least three compartments where it is dispersed into the supernatant under anaerobic conditions without mixing with the sludge. Indeed, the water and sludge mixture are under anaerobic conditions to promote anaerobic conversion of carbon into storage polymers to create sludge particles. The accumulated water and sludge mixture are passing to the current second compartment of the series of compartments where aeration is introduced to promote microbiological respiration.

The invention is in the field of wastewater treatment. The present invention relates an improved method and wastewater treatment plant.

### BACKGROUND

Wastewater is produced everyday by domestic or industrial activities. It must be purified from both organic and inorganic materials. This purification activity is generally centralized in large plants, wastewater treatment plants, in segregated locations. Wastewater contains various pollutants or undesirable substances, which wastewater treatment will seek to biodegrade, reduce and/or eliminate.

For this purpose, several plant designs can be used depending on the location, the available space, or the volume of wastewater to be treated.

For example, there are sequencing batch reactors (SBR) for wastewater treatment. In such systems, wastewater is added to a batch reactor containing activated sludge, where it is treated to remove undesirable components, and then the activated sludge is settled/sedimented to produce clarified water/supernatant which is then discharged. Operations are run according to a sequence in the same reactor, the level of water varies along the process. The wastewater is added to the reactor in a non-continuous manner (i.e. in a first step, to fill in the reactor). The treatment usually involves mixing flocculent activated sludge with the wastewater, in a turbulent phase, under oxygenation/aeration. Equalization, aeration, and clarification/sedimentation can all be achieved within a single batch reactor. To optimize the performance of the system, two or more batch reactors are used according to a predetermined sequence of operations. SBR systems have been successfully used to treat both municipal and industrial wastewater. They are suited for wastewater treatment applications characterized by intermittent flow conditions.

There are also continuous flow cyclic-operating activated sludge (CF-CAS) wastewater treatment systems, as for example described in EP1259465B1. Contrary to SBR systems, where all the treatment phases take place in a single isolated reactor, this system uses an ingenious process where several reactors or compartments, typically three or four reactors, connect with each other. There is always one reactor in a sedimentation phase allowing the sludge to settle and the supernatant to flow out as effluent, while the other reactors can receive wastewater and/or can run a biologically active phase. The function or phase of each reactor changes over time and alternates in a cyclic way. One of the great benefits of the system is the possibility of a continuous wastewater inlet flow and a continuous treated water outlet flow while being able to operate the reactors in a cyclic way. This allows to have a constant water level in all reactors or compartments at all times, as is the case for continuous flow reactors (CFR) for wastewater treatment.

In these reactors, the sedimentation efficiency generally depends on the settling surface of the reactor. These reactors therefore have a non-negligible footprint, which can be problematic in case of limited land availability to construct the wastewater treatment plant. To reduce the surface area of the CF-CAS system, the use of tube settlers has been generalized to improve the sedimentation rate per surface unit, as for example described in BE1024467B1. Tube settlers, as well known to the person skilled in the art, are structures usually placed within reactors, close to the surface, comprising settling planes that enable faster clearance of the supernatant layers of the treated water during the sedimentation phase.

However, firstly, these tube settlers are generally made of plastic media, thereby eventually participating to the negative environmental impact related to plastic production and pollution. Secondly, during aeration phases, tube settlers undergo a lifting force and need an additional anti-floating system to keep them properly positioned.

Therefore there is a need to develop compact reactors with low construction costs and generating no plastic burden.

Recently, the use of aerobic granular sludge (AGS) has appeared in SBR system. The characteristics and advantages of aerobic granular sludge are excellent settleability, high biomass retention, simultaneous nutrient removal, and tolerance to load variations. Recent studies show that aerobic granular sludge treatment could be a potentially good method to treat high strength wastewaters including elevated nutrient concentrations and toxic substances. The aerobic granular sludge can be directly cultivated in SBR systems and can be applied successfully as a wastewater treatment for high strength wastewater, industrial wastewater, and domestic wastewater.

The most well-known full-scale application of the AGS technology is the commercially available Nereda® technology, consisting of one or more SBRs that is/are fed from the bottom of the reactor while the sludge bed is settled.

AGS grown in SBR systems cannot be simply transposed or seeded in a CF-CAS system to result in a compact and plastic-free wastewater treatment plant. The CF-CAS system must be adapted to ensure growth, selection and long-term stability of such AGS, which would otherwise fail to result in such compact and plastic-free wastewater treatment plant. Indeed, the seeded AGS will disintegrate into flocculent sludge since the current configuration and control of the CF-CAS system does not allow the development of large aerobic granular sludge aggregates. As a result, it was considered necessary to develop a new process to produce and use AGS in a continuous flow cyclic-operating wastewater treatment system.

Therefore, to eliminate the use of tube settlers in CF-CAS reactors, the applicant deemed necessary to adapt the continuous flow cyclic-operating wastewater treatment process to the use of AGS.

The present invention therefore relates to an improved process of operating a continuous flow cyclic-operating aerobic granular sludge (CF-CAGS) wastewater treatment system, which overcomes one or more of the above disadvantages, without compromising functionality and benefits.

### SOLUTION OF THE INVENTION

The present application pertains to a wastewater treatment process within a continuous flow cyclic-operating wastewater treatment plant comprising a series of at least three reactors or compartments, comprising sludge, in hydraulic connection with each other, the process comprising:
growing, selecting and/or maintaining aerobic granular sludge (AGS) in at least one compartment of the plant, while
treating wastewater.

The advantage of growing the AGS within the wastewater treatment plant is that the bacterial growth will lead to AGS selected to operate in the context of this specific plant. This means that the AGS is adapted to the kind of impurities treated in that plant and efficiency is increased.

In the continuous flow cyclic-operating wastewater treatment plant, wastewater inlet is preferably performed at the top of the reactors. Treated water outlet is performed through weirs arranged at the surface of the reactors. The hydraulic connections between the compartments are preferably located towards the bottom or at the bottom of the compartments. Preferably, the hydraulic connections are provided with controllable means to be open or closed.

Growing, selecting and/or maintaining aerobic granular sludge (AGS), while treating wastewater is performed along a series of cycles, each including the various phases through which the water flows between the inlet and the outlet. A cycle involves that the incoming water flows through all compartments and undergoes biological processes, which can be under aerated or non-aerated conditions, mixed or non-mixed conditions and is followed by a sedimentation and effluent discharge step.

Each subsequent cycle preferably operates with a different inlet compartment and sedimentation/discharge compartment from the previous cycle.

A cycle or cyclic-operating process means that it alternates between main phases and intermediate phases. During a main phase, one compartment is in sedimentation/discharge phase while the other two or more compartments are actively running a biological process, such as feeding under feast conditions, regenerating under famine conditions, aeration under aerobic conditions and mixing under anoxic or anaerobic conditions. During an intermediate phase, one compartment is still in sedimentation/discharge phase, one or more compartment(s) is/are actively running a biological process, and one compartment is inactive to allow the sludge to settle and to become the sedimentation/discharge compartment in the next main phase. A critical parameter for the efficiency of the cycle is the duration of the various phases, merely the ratio of the duration of the intermediate phase to the main phase, which can depend on the characteristics of the AGS and the concentration of impurities to remove. The AGS is to be understood as aggregates or particles of microbiological origin, which do not coagulate under reduced hydrodynamic shear, and which subsequently settle significantly faster than activated sludge flocs. Typically, aerobic granular sludge consists of dense and compact granule structures with an average particle size equal or larger than 0.1 mm, preferably larger than 0.15 mm, preferably larger than 0.2 mm, while flocculent sludge consists of much smaller particles having a diameter below 0.1 mm. AGS has the advantage to settle faster compared to flocculent or activated sludge and typically has a sludge volumetric index (SVI) equal or lower than 100 ml/g MLSS (mixed liquor suspended solids). AGS has therefore a different shape than flocculent sludge, and a different density profile.

AGS sludge has excellent settling properties and as a result allows to operate at increased MLSS (mixed liquor suspended solid) concentrations in the compartments. Other and subsequent advantages of AGS include smaller reactor footprint, energy savings, increased biological treatment capacity, sustainable technology, robust technology, no sludge bulking and chemical treatment savings.

According to the invention, growing, selecting and maintaining aerobic granular sludge (AGS), while treating wastewater comprises:
(a) continuously receiving influent (waste) water into a first compartment of the series of at least three compartments where it is dispersed into the supernatant under anaerobic conditions without mixing with the sludge,
(b) continuously receiving influent (waste) water into a first compartment where it is mixed with the sludge while keeping the (waste) water and sludge mixture under anaerobic conditions to promote anaerobic conversion of carbon into storage polymers to create sludge particles (accumulation under feast conditions),
(c) passing the accumulated water and sludge mixture to the current second compartment of the series of compartments where aeration is introduced to create a dissolved oxygen gradient inside the sludge, and promote microbiological respiration (regeneration under famine conditions),
(d) passing the water and sludge mixture to said current last compartment of the series of compartments where sludge (at least in part in the form of particles at this stage) is continuously separated by gravity from the supernatant (sedimentation phase), while
(e) continuously discharging treated water/effluent from the current last compartment,
(f) preparing a compartment of the series of compartments (which was not yet a sedimentation compartment) to become the new last compartment for separation of sludge and supernatant in a new cycle of operation, by temporarily stopping circulation in, to and from this compartment, while discharging the treated water/effluent from the current last compartment of step (e), and receiving the influent (waste) water into another compartment, while the water and sludge mixture is being passed from the compartment receiving the influent (waste) water towards said current last compartment to provide continuous flow of treated water/effluent, and, in subsequent cycles of operation:
(g) repeating main phase steps (a) to (e) and intermediate phase step (f) in the new operating cycle, whereby all compartments of the first cycle become a series of hydraulically linked compartments in the new cycle with the new last compartment of step (f) being used for separation of sludge and treated water/effluent,
(h) repeating step (g) to rotate the cyclic operation of the compartments to obtain, select and/or maintain AGS.

The purpose of the process is to convert the activated sludge into granular sludge by creating the proper conditions for AGS proliferation and growth, which are also proper conditions for AGS maintenance, while at the same time purifying the influent (waste) water.

Depending on the maturity of the process, the sludge can contain more or less particles. It is expected that as from step (b), the sludge contains some particles. The sludge is then at least in part in the form of particles.

The “influent (waste) water” is to be understood as water, as an example and in a non-limitative way wastewater, flowing into the treatment plant, usually into a reactor of the plant through an inlet.

The “activated sludge” designates flocculent sludge, characterized by a low particle density and/or a low average particle size of below 0.1 or 0.2 mm, as well as pre-existing and/or degraded AGS. It is the purpose that flocculent sludge is grown into AGS during the process and that pre-existing or degraded AGS is respectively maintained or repaired. The activated sludge can come from an external source or be already present in the compartment, for example if the treatment plant was already running with conventional flocculent sludge, or as by-products of previous AGS or any other source. If coming from the existing settings, this can give the advantage that the sludge contains microorganisms already adapted to the particular setting of the plant and will lead faster to AGS.

In step (a), the influent wastewater is dispersed within the supernatant in a first compartment involves that the first compartment was previously in a sedimentation phase, with sludge accumulated at the bottom of the compartment and clarified water at the top, this clarified water being the supernatant. The sludge can be flocculent sludge, in the case of the very first cycles of a conversion from flocculent to AGS sludge) and/or in the form of particles in the case the process is more mature. Step (a) is a non-mixed anaerobic feeding step, i.e. without aeration and without mixing, in order not to mix the settled sludge with the fed wastewater yet. This leads to substrates building-up into the supernatant, while the sludge remains unfed. The substrates from the influent wastewater are the impurities to be metabolized by the sludge in the next phases and thereby serving as food and energy for the sludge.

In step (b), still under anaerobic conditions, mixing is initiated in the first compartment. The supernatant rich in substrates is mixed with the sludge, resulting in a sudden exposure to food and a sharp Food/Mass (F/M) ratio. The F/M ratio is the balance between the food available and the sludge biomass in the reactor. An increased availability to substrates under anaerobic conditions further promotes anaerobic carbon uptake and conversion to polyhydroxyalkanoates (PHA). Also, the substrates abundance is extended by continuously receiving influent wastewater and diluting the sludge concentration, promoting carbon uptake to an even higher extend to result in particle formation, and selection. This is the accumulation phase, feast phase or mixed feeding phase.

Steps (a) and (b) are preferably run one after the other in the first compartment.

The “feast conditions” preferably comprise keeping the sludge under anaerobic conditions in presence of an excess of substrate to promote the conversion of VFA (volatile fatty acids) into PHA by PHA accumulating bacteria and to suppress the normally faster-growing ordinary heterotrophic bacteria. The transition between non-mixed feeding and mixed feeding creates a shock to the bacteria to promote anaerobic carbon uptake accompanied by phosphorus release. Anaerobic feeding strategy is suitable to enhance granulation and is based on the presence and enrichment of specific groups of PHA accumulating bacteria, like PAOs (phosphate accumulating organisms) and GAOs (glycogen accumulating organisms), that share the ability to convert carbon into storage polymers under anaerobic conditions. This allows the formation of larger sludge particles and granules.

Then, famine conditions are applied after such feast conditions.

In step (c), passing the accumulated wastewater and sludge mixture to the current second compartment of the series of compartments where aeration is introduced to create a dissolved oxygen gradient inside the sludge, and promoting microbiological respiration, means that sludge particles flow from the first compartment where they were kept under anaerobic conditions to the second compartment where they are subjected to aerobic conditions. There is no influent wastewater introduced from the top of this second compartment. This allows to assure maximum enrichment of slow-growing granule forming bacteria which rely on the aerobic conversion of the stored PHA.

At this stage, the substrate concentration in the wastewater and sludge mixture is low, hence the famine phase, regeneration phase or aerated non-feeding phase.

During the famine phase, bacterial activity and/or particle size and/or particle concentration can be monitored.

For example, the degradation of PHA and nitrification may be monitored by measuring the oxygen uptake rate (OUR) in order to ensure maximum enrichment of slow-growing granule forming bacteria. The OUR parameter indicates whether or not aerobic conversion and regeneration are complete: as long as bacteria are active in their aerobic metabolism, dissolved oxygen is consumed. When all substrates are metabolized, the bacterial respiration stops leading to an increased dissolved oxygen concentration. To the same extent, in addition or alternatively, dissolved ammonium, phosphate, nitrates concentration can also be monitored as a measure of bacterial activity.

The increase of the amount of sludge particles and the movement of the AGS may be monitored using a mixed-liquor suspended solids (MLSS) sensor. The MLSS concentration gives information on the concentration of sludge particles, as well as the migration of the sludge particles between the compartments.

Other sensors may also be used to provide alternative or complementary information like pH sensors, thermometers, DO sensors, redox sensors, conductivity sensors, turbidity sensors, flowmeters, ammonium nitrates and/or phosphate sensors.

The alternating feast and famine conditions are therefore applied in order to promote anaerobic carbon uptake and conversion to storage polymers like PHA followed by the consumption of intracellular polymers during the subsequent aerobic phase. This strategy is applied with the aim to enrich slow-growing organisms as a means to develop stable AGS.

During the feast phase in the accumulation compartment the activated sludge is being fed and maintained under anaerobic conditions, meaning low redox conditions throughout the complete granule formed or in formation, promoting anaerobic VFA uptake and phosphorus release. During the subsequent famine phase in the regeneration compartment the granules are not being fed and are being aerated, meaning different redox layers due to dissolved oxygen diffusion limitations inside the granule. This is the result of dissolved oxygen consumption in the outer layers. Consequently, an aerobic outer zone coexists together with an anoxic inner zone. The aerobic zone of the AGS contributes to the nitrification reactions, the growth of PHA accumulating organisms and the aerobic phosphorus uptake. The presence of an anoxic zone of the AGS contributes to the denitrification reactions, growth of denitrifying PHA accumulating organisms and anoxic phosphorus uptake. During aeration, dissolved oxygen will diffuse towards the core of the AGS granules. The presence of an aerobic outer layer and an anoxic inner core, facilitates co-existence of nitrifying organisms together with aerobic PHA accumulating organisms in the outer layers of the granules and denitrifying PHA accumulating organisms in the inner layer of the granules.

In step (d) the regenerated wastewater and sludge mixture flows towards said current last compartment of the series of compartments where sludge is continuously separated by gravity from the supernatant. This means, while the first compartment is operating a biological process under anaerobic conditions, the second compartment is operating a biological process under aerobic conditions, the last compartment is not running a biological process but a sedimentation phase, along with step (e) of discharging the treated water/effluent. When reaching this compartment, the sludge should, at least in part, be in the form of particles. During the very first cycles of the process, there may still be a large amount of flocculent sludge present in the mixed liquor, while when the process is more mature, there may mainly particles or AGS.

The “effluent” designates treated water discharged from the plant, preferably clarified water, i.e. water that is separated from solid mass and has a low substrate/impurities concentration. An acceptable substrate concentration can depend on the location of the plant, destination of the effluent water, or legislation in place. There are known KPIs (Key Performance Indicator) for assessing the effluent quality. The effluent is discharged through an outlet, usually using a weir. Steps (a) to (e) constitute a main phase of operations of the plant. It is then the purpose to rotate the function of the compartments, to change the flow direction between the compartments, to redistribute the AGS and to ensure homogeneous growth, selection and maintenance of the AGS in all compartments, while also ensuring proper purification of the water.

After a certain period of time, or advantageously when certain predetermined criteria are reached, in step (f), a compartment of the series of compartments (a compartment that was previously running a biological process) is prepared to become the new last compartment for separation of sludge particles and supernatant in a new cycle of operation, by temporarily isolating this preparation compartment, while discharging the effluent from the current last compartment, and receipt of influent wastewater into a compartment which is not a sedimentation, while the wastewater and sludge mixture is being passed from the compartment receiving the influent wastewater towards said current last compartment to provide continuous flow of effluent.

Step (f) is an intermediate phase. Depending on whether the current regeneration compartment or the current accumulation compartment is being prepared to become the next sedimentation compartment, and whether the current accumulation compartment or the current regeneration is receiving the influent wastewater during the intermediate phase, the cycle is either labelled as symmetrical or asymmetrical. In the symmetrical cycle, all compartments in a series of at least three compartments rotate the consecutive functions of accumulation, regeneration, preparation/sedimentation and effluent discharge/sedimentation. In the asymmetrical cycle, only two out of a series of at least three compartments rotate these same consecutive functions. The remaining compartments in such asymmetrical cycle, rotate between accumulation and regeneration, but have no preparation/sedimentation and effluent discharge/sedimentation functions.

Starting steps (a) and (f) comprises acting upon some means to open or close the inlets, outlets and hydraulic connections between the compartments.

Then, in step (g), a new operating cycle is started by repeating main phase steps (a) to (e) and intermediate phase step (f), whereby all compartments of the first cycle become a series of hydraulically linked compartments in the new cycle with the new last compartment of step (f) being used for separation of sludge particles and effluent.

The same cycle is repeated again and again to rotate the cyclic operation and functions of the compartments to obtain, select and/or maintain AGS.

During an initial period of AGS formation and selection, i.e. starting from flocculent sludge exclusively, it is possible that AGS maturity is only reached after a large number of cycles. During that period, the effluent can be normally discharged, as growth of the AGS still consumes impurities thereby cleaning the water.

When AGS is mature, it still needs to be maintained to ensure AGS process efficiency. The wastewater-treatment process continues to be operated in a series of at least three compartments with continuous flow using alternating non-mixed anaerobic feeding, mixed anaerobic feeding, aerobic mixing, preparation/sedimentation and sedimentation/discharge phases, which is not the case in other existing CFR systems or SBR systems.

The advantage of the process of the invention is to be dynamically manageable. By monitoring some properties in each compartment, the duration of the main phases and intermediate phases can be dynamically adapted. An algorithm can be defined to combine information (measures) retrieved from each compartment (through the sensors) and decide when a main phase is stopped and intermediate phase (f) is started, and subsequently when intermediate phase (f) is finished and new main phase of steps (a) to (e) is started.

This is also applicable for dynamically adapting the duration of steps (a) and (b).

The process of the invention is preferably fully automated, meaning that the method of the invention is controlled by a software, which is arranged to dynamically control the duration of at least one main phase (steps (a) to (e)) and/or intermediate phase (f), in relation with the status of some parameters within the compartment.

So, the process of the invention preferably comprises monitoring parameters in each compartment in order to extract information related to the status of the biological process and/or the settling process and determining or adjusting, depending on these statuses, the duration of steps (a) to (e). It can be about determining or adjusting the duration of the ongoing step or of a future step.

The total duration of steps (a) and (b) will be equivalent to the duration of step (c) and the duration of step (d) and (e). The algorithm can for example foresee that when suitable parameters are achieved in the first and the last compartment, intermediate phase (f) is started, or for example it can foresee that intermediate phase (f) can only be started if predetermined criteria are reached within all compartments.

Associated to the method, the invention also relates to a continuous flow cyclic-operating aerobic granular sludge (CF CAGS) (waste) treatment plant comprising a series of at least three compartments with hydraulic connections between each other, the plant comprising:
influent water inlet means arranged at the top of the compartments equipped with valves;
weirs arranged towards the top of the compartments for discharging effluent;
hydraulic connections between the compartments, preferably located towards the bottom or at the bottom of the compartments;
means (like valves) to open or close the hydraulic connections;
mixing means within the compartments;
aeration means within the compartments;
means to measure parameters within the compartments
a driving unit for receiving and analyzing the parameters measured within the reactor, and, in function of the output of this analysis, manage the influent water inlet, the discharge of clean water through the weirs, the mixing means, the aeration means, and/or the hydraulic connections between the compartments.

Preferably, all compartments are provided with the same equipment, like for example an influent valve located above the compartment, an aeration system arranged to diffuse air or pure oxygen within the water in the compartment, a mechanical stirrer, a sludge pump or valve, sensors and their signal transmitters, an effluent valve and/or valves regulating the hydraulic interconnections between the compartments, located at the bottom of or below the compartments.

The driving unit is typically a CPU within a computer system or server in which a program is installed, which, when run, can receive the information from the means to measure parameters and send information and/or orders to the valves, the means to open or close the hydraulic connections, the mixing means, the aeration means and/or the excess sludge evacuation means of the compartments.

Advantageously, the means to measure parameters within the compartments can be sensors like MLSS sensor, flow meters, thermometers, DO (dissolved oxygen) sensors, pH sensors, redox sensors, conductivity sensors, turbidity sensors and/or ammonium, nitrates, phosphate sensors. The sensors integrated into the compartments allow data to be acquired, in order to monitor the status of the various phases of the cycles and adjust various operational parameters in consequence, like for example the duration of a specific phase. These sensors allow to have real time data and thus to be able to accelerate some cycles for saving time and/or optimize process efficiency. In most SBR systems, each phase has a predefined duration. In the plant of the invention, phases and thereby cycles have a dynamically calculated duration.

For example, the increase of the amount of sludge particles and the movement of the AGS can be monitored using a MLSS sensor. The MLSS concentration gives information on the concentration of sludge particles, as well as the migration of the sludge particles between the compartments.

The plant can further comprise means to remove the excess sludge from the compartments, which can advantageously be managed by the driving unit, in order to control the sludge concentration in the compartments.

Other sensors can also be used to provide alternative or complementary information like pH sensors, DO sensors, redox sensors, conductivity sensors, turbidity sensors, flowmeters, ammonium nitrates and/or phosphate sensors.

The parameters detected within the compartments can for example be MLSS, dissolved oxygen levels, pH, conductivity, redox status, flow, turbidity, and/or ammonium nitrates and/or phosphate concentration, or any other relevant parameter. From these parameters, other data can be extracted which can comprise average particle size, impurity levels, . . . .

Preferably, all compartments are arranged to run the same operations in a symmetrical or asymmetrical cycle: a biological step and a settling/discharge step, while having a constant water level and a continuous influent inflow and effluent outflow for both the overall system as for the hydraulically connected individual units. A separate sedimentation tank and/or sludge raking and/or sludge recirculation devices are not needed. The terms reactor, tank and compartment are used indifferently.

### DETAILED DESCRIPTION OF THE INVENTION

The invention will be better understood from reading the following detailed description of non-limiting implementation examples thereof, and with reference to the appended drawings, in which:

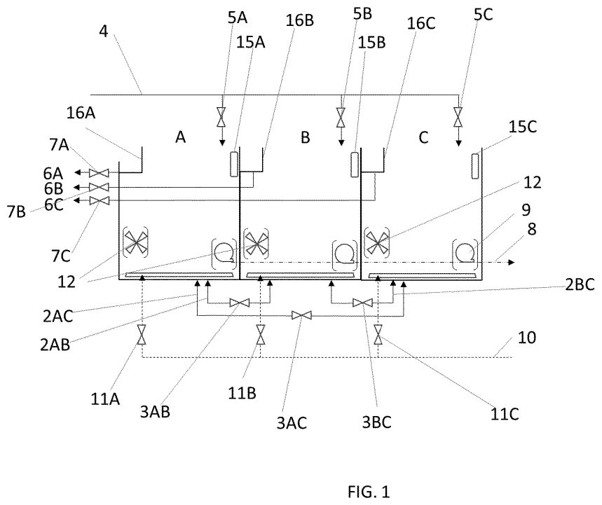

FIG. 1 is a scheme of a (waste) water treatment plant according to the invention;

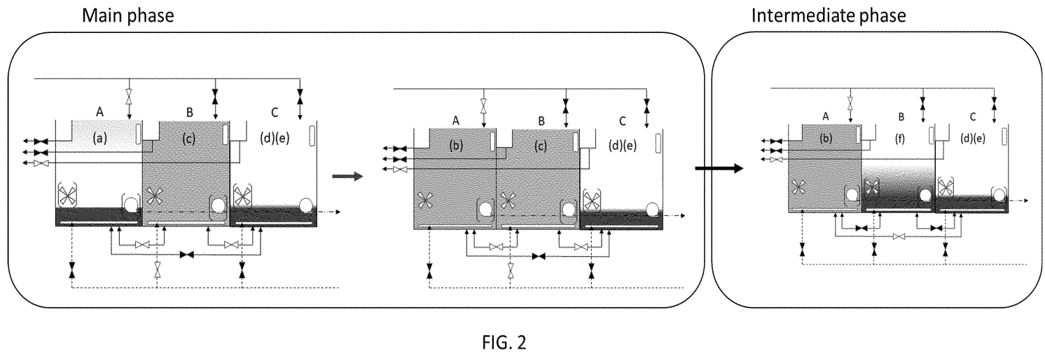

FIG. 2 is a scheme of an AGS formation, selection and/or maintenance symmetrical cycle within the reactor of FIG. 1;

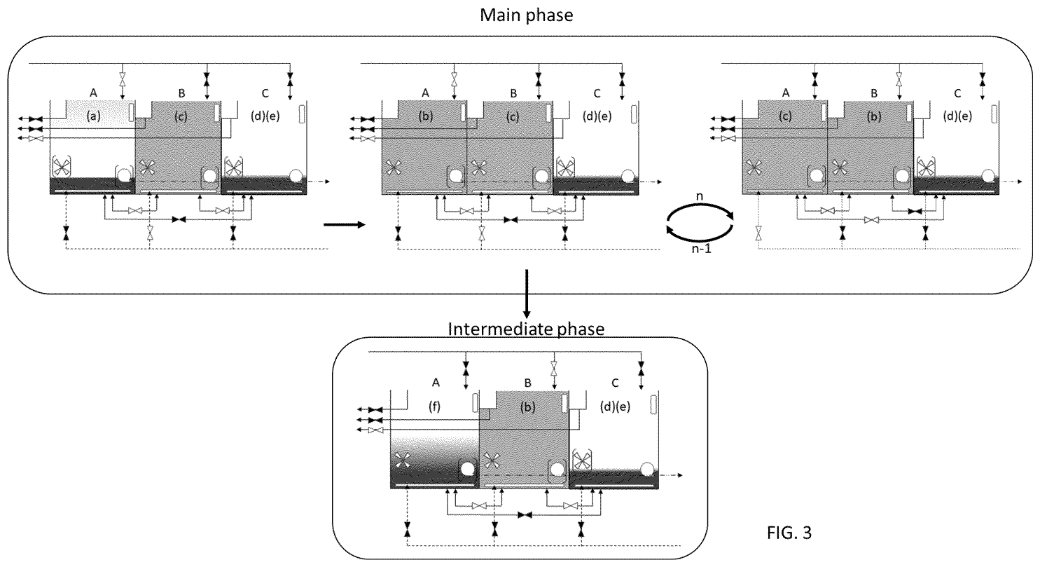

FIG. 3 is a scheme of an AGS formation, selection and/or maintenance asymmetrical cycle type I within the reactor of FIG. 1;

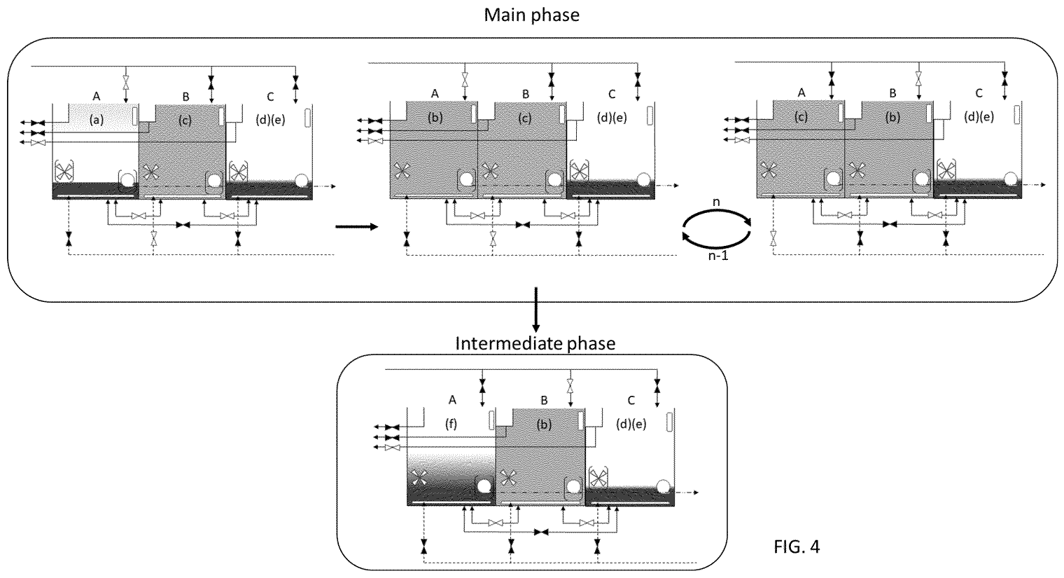

FIG. 4 is a scheme of an AGS formation, selection and/or maintenance asymmetrical cycle type II within the reactor of FIG. 1;

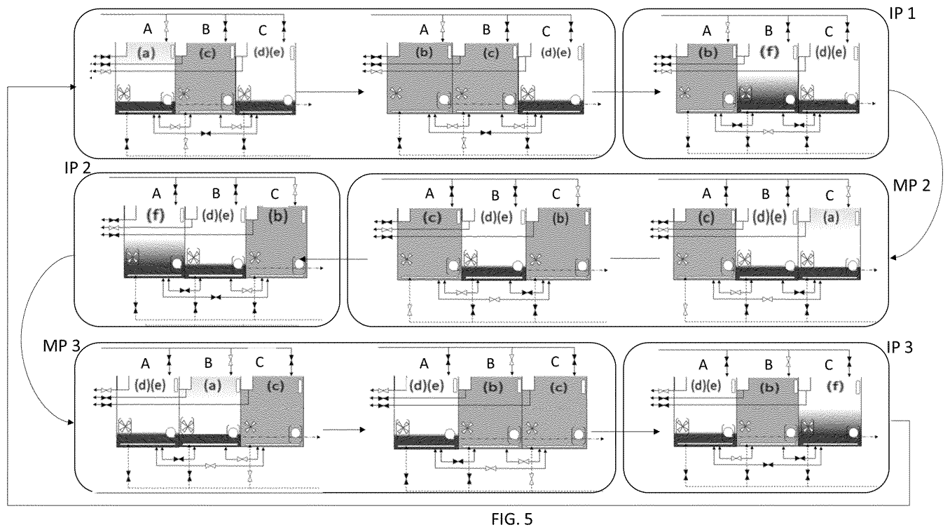

FIG. 5 illustrates a symmetrical cyclic-operating wastewater treatment process within the plant of FIG. 1

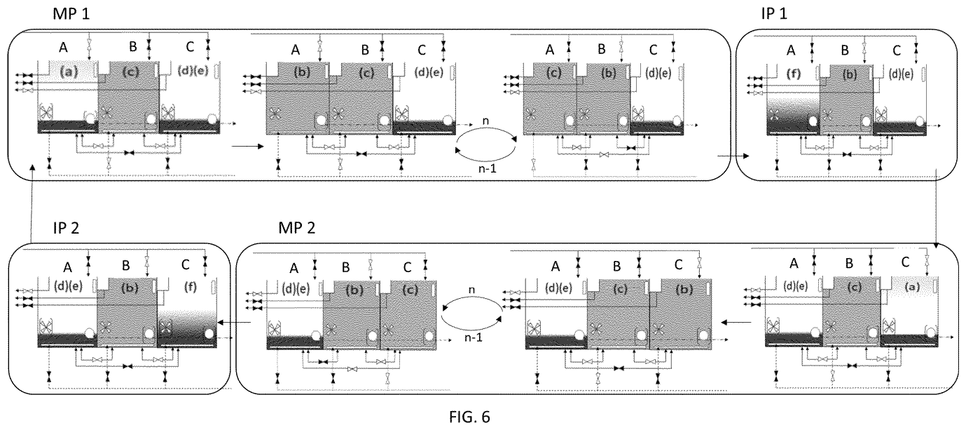

FIG. 6 illustrates a type I asymmetrical cyclic-operating wastewater treatment process according to the invention, within the plant of FIG. 1;

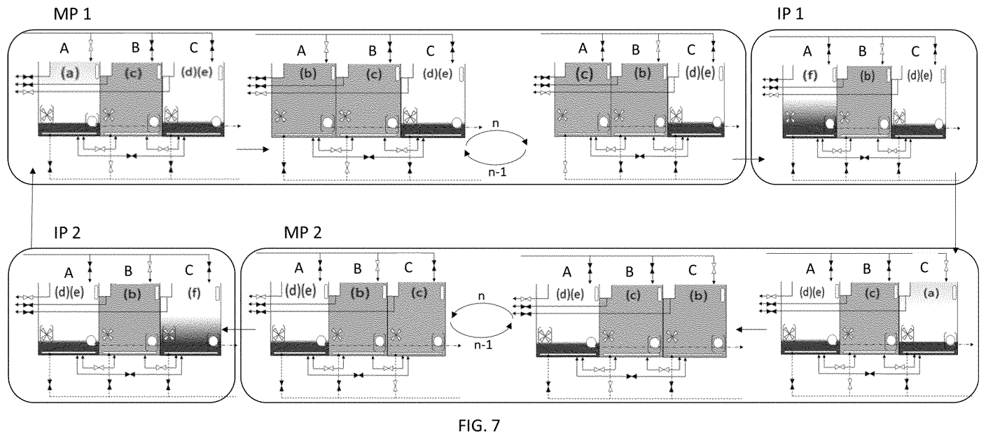

FIG. 7 illustrates a type II asymmetrical cyclic-operating wastewater treatment process according to the invention, within the plant of FIG. 1;

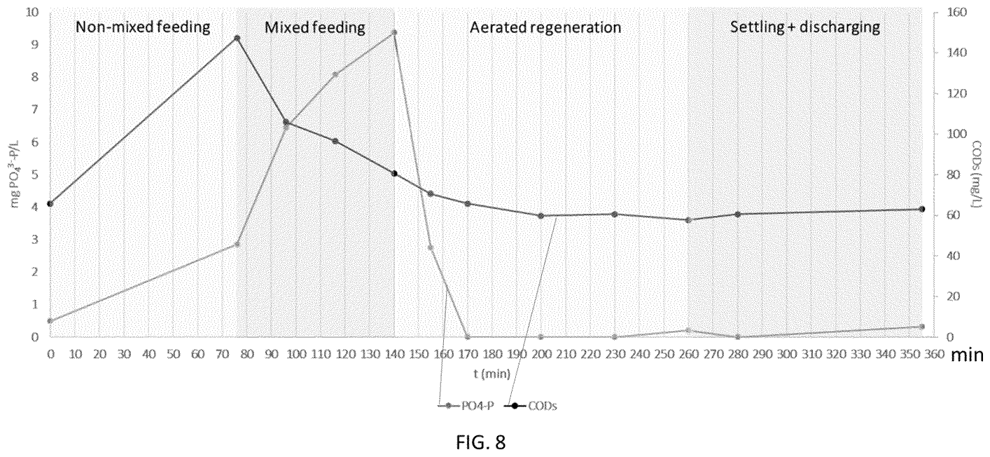

FIG. 8 is a graph representing the evolution over time (days) of the in-situ CODs and phosphate concentration profile in one compartment during a symmetrical cycle as illustrated on FIG. 5;

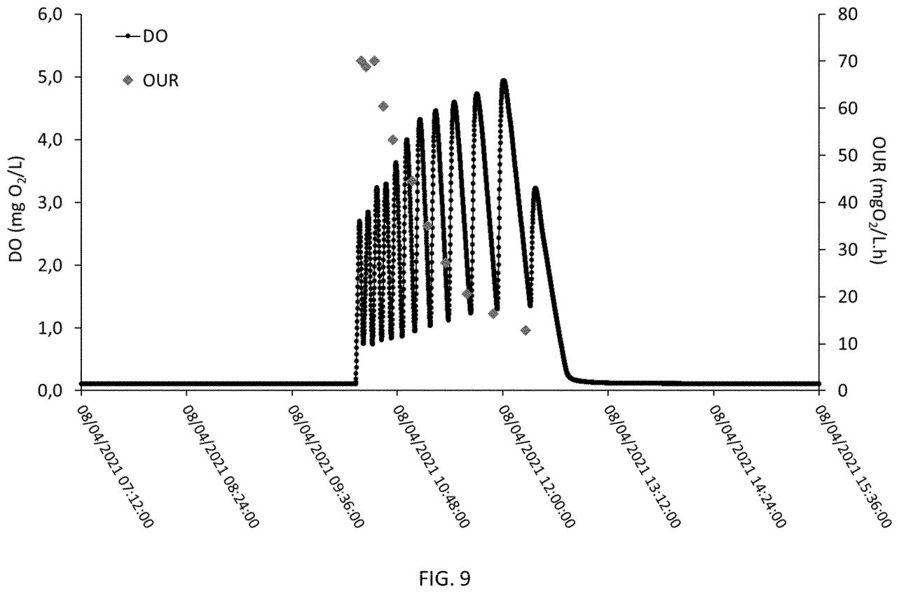

FIG. 9 is a graph representing the evolution over time, within one day, of the DO concentration profile with calculated OUR values in a regeneration compartment during a symmetrical cycle as illustrated on FIG. 5;

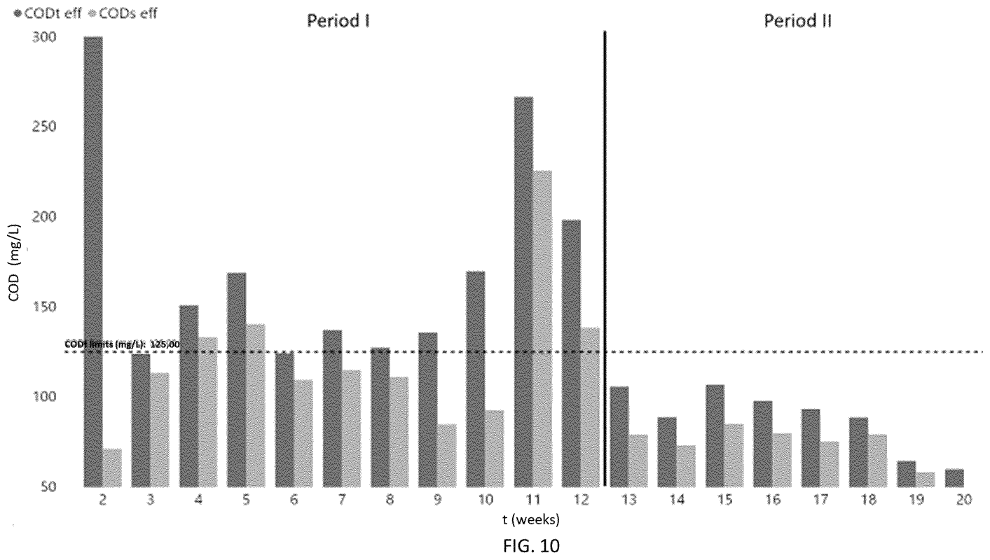

FIG. 10 illustrates the weekly evolution of the average effluent CODt and CODs concentrations;

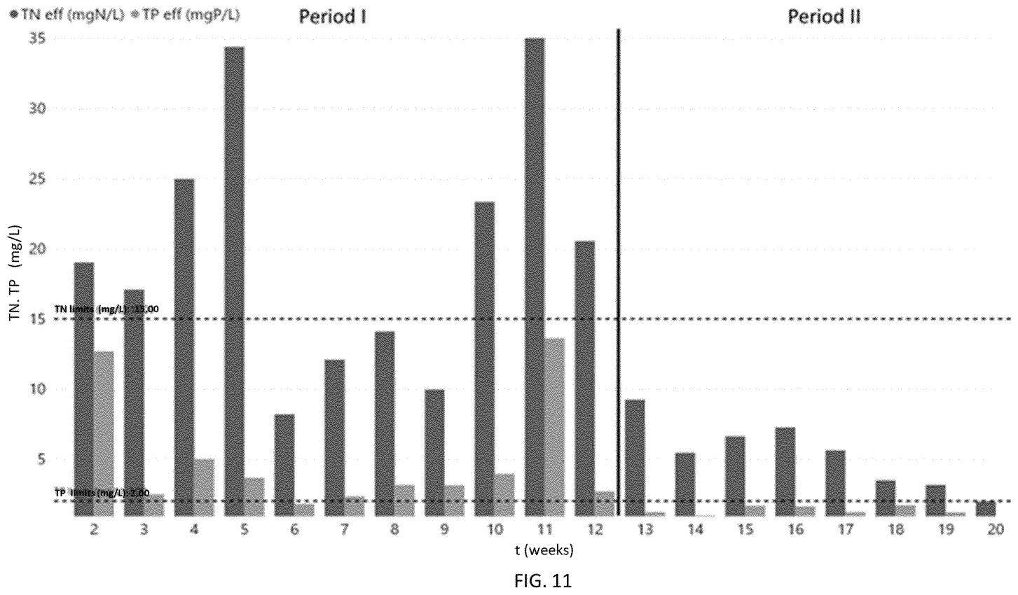

FIG. 11 illustrates the weekly evolution of the of the average effluent TN and TP concentrations;

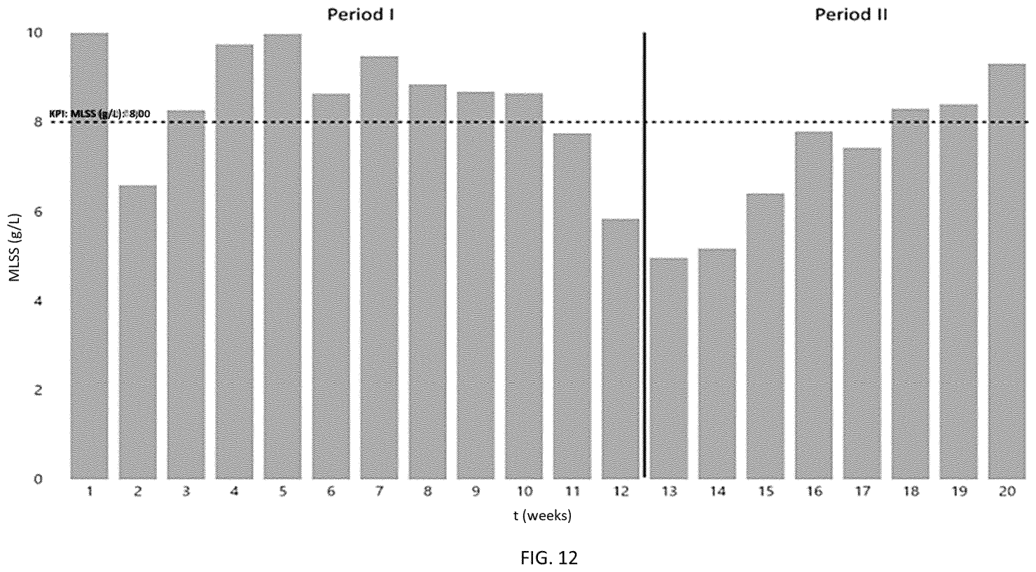

FIG. 12 illustrates the weekly evolution of the of the average MLSS concentration;

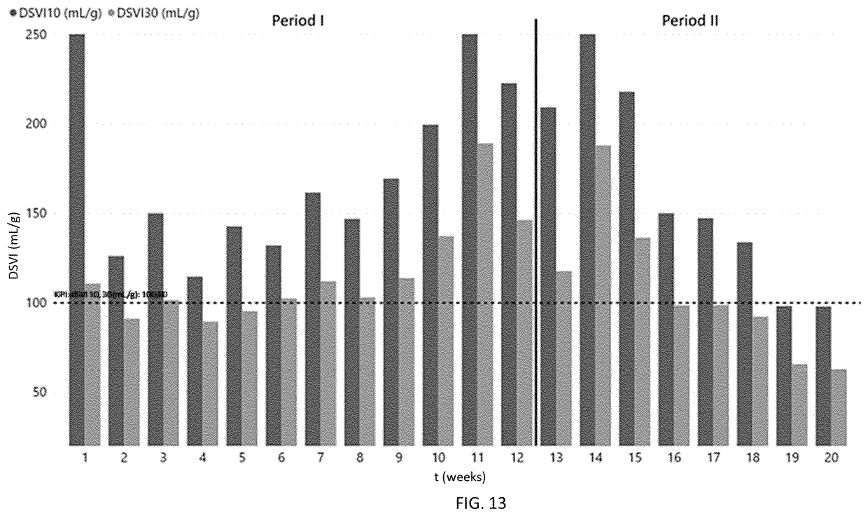

FIG. 13 illustrates the weekly evolution of the of the sludge settling characteristics;

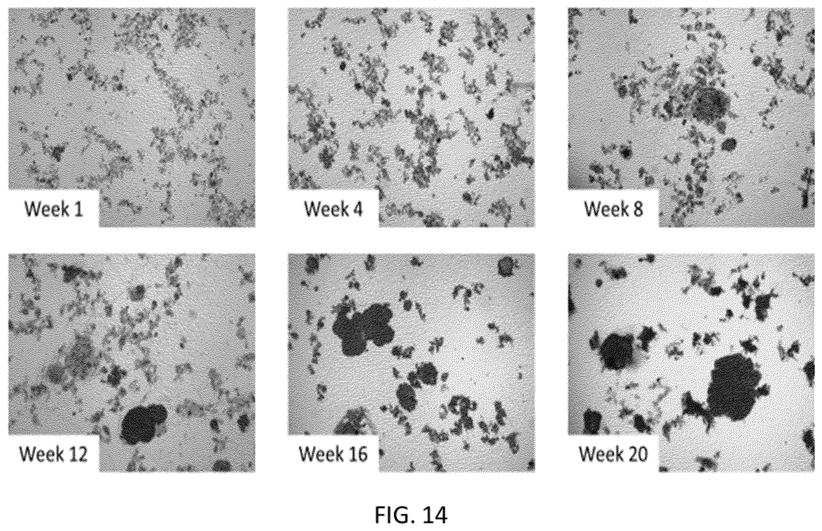

FIG. 14 are pictures of the sludge morphology at various points of time (magnification: 40×).

### DEFINITIONS AND ABBREVIATION

CODt (mg O₂/L): total chemical oxygen demand, measured using photometric methods of NANOCOLOR® Macherey-Nagel.

CODs (mg O₂/L): soluble chemical oxygen demand, measured using photometric methods of NANOCOLOR® Macherey-Nagel.

VFA (mg Ac/L): volatile fatty acids, measured using photometric methods of NANOCOLOR® Macherey-Nagel. VFA is representative of the effectiveness of the digestion process.

TN (mg N/L): total nitrogen, measured using photometric methods of NANOCOLOR® Macherey-Nagel.

TP (mg P/L): total phosphorus, measured using photometric methods of NANOCOLOR® Macherey-Nagel.

TSS (mg/L): total suspend solids, determined using the standard method (APHA, 2005).

MLSS (g/L): mixed liquor suspended solids, determined using the standard method (APHA, 2005).

MLVSS (g/L): the mixed liquor volatile suspended solids, determined using the standard method (APHA, 2005).

MLSS and MLVSS are representative of the growth and movement of the sludge particles.

DSVI₁₀ (mL/g): diluted sludge volume index after 10 minutes settling, calculated using the following equation:

$$( D ) {SVI}_{10} ( \frac{mL}{g} ) = \frac{{SV}_{10} ( \frac{mL}{L} ) \cdot ( dilution factor )}{MLSS ( \frac{g}{L} )}$$

where SV₁₀ (mL/L) is the undiluted volume index after 10 minutes of settling;

DSVI30 (mL/g): diluted sludge volume index after 30 minutes of settling, calculated using the following equation:

$$( D ) {SVI}_{30} ( \frac{mL}{g} ) = \frac{{SV}_{30} ( \frac{mL}{L} ) \cdot ( dilution factor )}{MLSS ( \frac{g}{L} )}$$

where SV₃₀ (mL/L) is the undiluted volume index after 30 minutes of settling.

DSVI indexes are representative of the settling process.

Referring to FIG. 1, a (waste) water treatment plant according to the invention comprises three hydraulically connected compartments A, B and C. The compartments A, B and C are each connected with the two other compartments via direct hydraulic connections arranged below the compartments, respectively 2AB, 2AC and 2BC each equipped with a valve 3AB, 3AC and 3BC respectively. An influent feeding inlet 4 is arranged with inlet splits directed above each compartment equipped with opening valves 5A, 5B and 5C respectively.

Effluent weirs 16A, 16B and 16C are arranged respectively inside each compartment at water level. Each weir is hydraulically connected to an effluent pipe 6A, 6B and 6C respectively, each pipe being equipped with an effluent valve 7A, 7B, C respectively. An excess sludge evacuation pipe 8 is arranged which connects to a sludge pump 9 in each compartment. Each compartment is also equipped with a mixer 12 (or mixing means) and an aeration gas inlet 10 equipped with a valves 11A, 11B and 11C respectively for allowing air or pure oxygen flowing inside the compartments. Sensor units 15A, 15B and 15C are respectively arranged within the compartments below water level.

The valves described above are here typically valves or penstocks for opening and closing the influent inlets, effluent outlets, the hydraulic connections, the excess sludge outlets and the aeration gas inlets. They can be manual, but are preferably automated.

Now that the plant has been described, the operations for AGS growth cycles and wastewater treatment will be described.

As example, the process to grow, select and/or maintain AGS while treating wastewater is described in reference to FIG. 2, within the (waste) water treatment plant arrangement of FIG. 1 (reference numbers of FIG. 1 have not been transposed to FIG. 2 for clarity purpose, but should be considered). Valves drawn fully in black are closed while valves in white are open, for the purpose of illustration. For the first cycle, compartment A is in hydraulic connection with compartment B (valve 2AB open), which is in hydraulic connection with compartment C (valve 2BC open). Compartment A is not in direct communication with compartment C (valve 3AC closed). Inlet valve 5A is open, while valves 5B and 5C are closed. Outlet valves 6C is open, while outlet valves 6A and 6B are closed. Aeration valve 11B is open, while aeration valves 11A and 11C are closed.

The first cycle starts with a step (a) of continuously receiving influent wastewater into a first compartment A where it is dispersed into the supernatant without mixing with the sludge. The supernatant must be understood as the relatively clear water layer on top of the sludge bed. The sludge bed sits settled on the bottom of the compartment or reactor. This implies that at the step preceding step (a), the first compartment was not under mixing nor aeration, but in a sedimentation/discharge phase.

The raw wastewater here comes from an equalization tank at a brewery site, which is a holding basin where variations in flow and composition of a liquid are levelled out. Before entering compartment A, the wastewater was sieved manually using a sieve for example with pore sizes of 0.5 mm or 1 mm in order to remove large particular waste.

The experiment here starts with growing and selecting AGS from flocculent sludge and then maintaining the AGS over time. The activated, flocculent sludge here comes from a two-stage wastewater treatment plant and sludge treatment plant located at the same brewery site. Flocculent sludge was collected from two different tanks with 50% of the high loaded stage and 50% of the sludge thickening tank.

The sludge characteristics were evaluated by the evolution of the sludge settling properties, the sludge morphology at microscopic level and the MLSS/MLVSS concentration in the reactor. The MLSS and MLVSS concentrations were determined according to the standard methods. A grab sample of biomass is taken in aerated compartment B to be analyzed afterwards according to the above-mentioned method. The sludge settling characteristics were evaluated through determination of the diluted SVI after 10 (dSVI₁₀) and 30 (dSVI₃₀) minutes.

Instead of a regular SVI determination, the diluted SVI was measured in order to avoid hindered settling due to increased biomass concentrations. Therefore, the sludge grab sample, taken during aerobic phase, was diluted using effluent from the same reactor.

Though the measures are here described using sampling and laboratory analysis of the sample, it is the intention that a plant operates using in situ sensors for at least part of the measured parameters.

The diluted SVI was determined for each compartment on a weekly basis using a graduated 1L cylinder.

For the brewery wastewater influent CODt, CODs, VFA, TN and TP concentrations were determined. A sample of influent water is taken at regular intervals to be analyzed afterwards using the photometric methods of NANOCOLOR® Macherey-Nagel.

While the wastewater is entering in compartment A, no mixing nor aeration is applied to leave the settled sludge bed undisturbed as much as possible. This is a non-mixed feeding phase. This results in substrate accumulation in the higher part of compartment A. After a certain volume of wastewater has been added to compartment A, the next step (b) is initiated.

In step (b), occurring after step (a) (second representation on FIG. 2), influent wastewater 4 continues to flow into compartment A through valve 5A. Mixing is started in the compartment, generated by mixing and/or aeration means, for example mixer 12, thereby suddenly placing the activated sludge in contact with a large amount of substrate (that had been accumulating in the supernatant). This represents a feast for the sludge which is kept under anaerobic conditions to promote anaerobic conversion of carbon (from the substrate or impurities) into storage polymers and to create particles. This is a mixed-feeding step or accumulation step.

Parameters like MLSS, COD and the phosphate level (see FIG. 8) are monitored during this step, either by sampling and consequent lab analysis or using the sensors 15A in compartment A.

After a certain time under consecutive non-mixed and mixed anaerobic conditions, some flocculent sludge converts into particles. The substrate concentration in the wastewater significantly diminishes. The mixture of wastewater and sludge conveys into compartment B via the hydraulic connection 2AB with open valve 3AB following the flow between these compartments.

Next step (c) occurs in compartment B by introducing aeration (valve 11B open) into the wastewater and sludge mixture to create a dissolved oxygen gradient inside the sludge particles and promote microbiological respiration. This is a famine phase or regeneration step. The monitoring of dissolved oxygen (see FIG. 9), ammonium, nitrates, and phosphate concentrations in this compartment gives a good image of the status of the step. When no more dissolved oxygen is consumed, or when the production rates of nitrates and/or phosphate stabilize, this means that this step has reached a maturity. Continuous monitoring of these parameters can allow to determine when this step has reached its optimal duration. MLSS and other information can be measured within the sensors unit 15b, which can for example comprise a MLSS sensor, a pH sensor, a DO sensor, a redox sensor, a conductivity sensor, a turbidity sensor, a flow meter, an ammonium, nitrates and/or a phosphate concentration sensor.

Note that the term “sensor unit” does not necessarily mean that all sensors are located in the same place, the sensors can be at different locations within the compartment.

During step (c), at least some of the particles formed during step B are converted into AGS.

The mixture of wastewater and sludge is transferred from compartment B to compartment C via the hydraulic connection 2BC with open valve 3BC, following the flow between these compartments. Step (d) occurs in compartment C. The metabolized wastewater is separated from the sludge in this last compartment C of the series of compartments. A sludge bed is formed at the bottom of the compartment and a supernatant layer is formed on top of the sludge bed, so that clean water flows through effluent weir 16C in step (e).

Excess sludge or biomass can be discharged from compartment C by sludge discharging means 8.

Steps (a) to (e) occur in the three compartments of the plant. They can occur in parallel. This is made possible by the continuous flow within the plant. As a consequence, there is a need for synchronization of the duration of the steps along the cycle, before starting the intermediate phase step (f) where the connection between compartments and function on some compartments are changed for a subsequent step or phase.

When sensors are implemented in each compartment, the completion of each step or phase can be monitored. For example, the duration of the biological anaerobic steps (a)+ (b)) in compartment A, the biological aerobic step (c) in compartment B, and the sedimentation/discharge steps (d)+ (e) in compartment C are identical.

The above steps (a) to (e) constitute a first main phase of the AGS growth cycle. In order to grow AGS equally in all compartments, the setting of the plant is modified in step (f) where compartment B is prepared to become the new settling compartment in a new main phase. In the symmetrical AGS growth cycle, this is achieved by temporarily isolating compartment B from the other compartment, by closing valves 3AB and 3 BC and opening valve 3AC. Water flows then directly from compartment A to compartment C. The wastewater-sludge mixture from compartment A is thereby transported towards compartment C to provide continuous flow. This is the first intermediate phase.

The cycle illustrated on FIG. 2 is a symmetrical cycle.

There can also be other types of cycles, which can be called “asymmetrical”. Two types of asymmetrical cycles are illustrated below in relation with FIGS. 3 and 4.

For both types illustrated, in the intermediate phase, the influent is fed into compartment B, while in the main phase, the influent is fed either into compartment A (during the main phase 1) or into compartment C (main phase 2). In an asymmetric AGS growth cycle, according to the invention, two types of cycles can be found: the type I cycle (FIG. 3) and the type II cycle (FIG. 4). The difference between an asymmetric type I cycle and an asymmetric type II cycle is the procedure by which the outer compartments A and C are regenerated in the main phase.

In an asymmetric type I cycle, the regeneration of the outer compartment takes place on-line, which means that the regenerated compartment receives the mixture of water and sludge from the accumulated compartment B. In an asymmetrical Type II cycle, the regeneration of the outer compartment takes place off-line, which means that the regenerated compartment does not receive the water and sludge mixture from the accumulated compartment B.

FIG. 3 illustrates an asymmetric type I cycle. In the main phase of the cycle, the influent flows from compartment A to compartment B and then to C. Valves 3 from A to B and B to Care open while valve C from A to C is closed. Thus the connection between compartment A and compartment C is open whereas the connection between compartment C and compartment B is closed so that the flow goes into B to A to C and out (and not directly from B to C).

The main phase 1 of the asymmetric type I cycle consists of several consecutive events. Firstly, a non-mixed accumulation in A and regeneration in B. Secondly, a mixed accumulation in A and regeneration in B. Thirdly, a mixed accumulation in B and (online) regeneration in A. The second event (mixed accumulation in A+regeneration in B) can be done once (n=1 and n−1=0 so no repetition) or can be repeated multiple times (n> or =1) before the main phase goes into the intermediate phase. Anyhow the second event is always followed by the third event (mixed accumulation in B+regeneration in A, where the flow of influent is switched to compartment B towards compartment A and then to compartment C).

FIG. 4 illustrates an alternative embodiment, where the main phase of an asymmetric cycle is of so-called type II, the regeneration of AGS being done offline.

The flow of the influent goes from compartment A to compartment B then to compartment C. The AGS then accumulate in compartment A and their regeneration occurs in compartment B. Then influent enters into compartment B towards compartment C, valves BC and effluent from C are open, valve AC is closed and valve BA is open while effluent from A is closed. Therefore, the regeneration then takes place off-line in compartment A, through which no water flows. The flow of the influent goes from compartment B to compartment C to be released as the effluent, and without passing over compartment A, even though the connection between compartment B and A is open. Compartment A is therefore said “offline”.

The asymmetrical AGS growth cycle type I, as disclosed on FIG. 3, can be considered as a practical simplification of the symmetrical AGS growth cycle. Indeed, during every step or phase in the asymmetrical cycle, the position of the valves 3AB, 3BC and 3AC remains unchanged, and therefore these valves can be either replaced by a hydraulic opening (3AB and 3 BC) or omitted (3AC) from the setting of the plant. In this configuration. In this asymmetrical cycle, the settling function of compartment B is abandoned, and therefore the overflow weir 16B, effluent pipe 7B and effluent valve 6B can eventually be omitted. Likewise, the asymmetrical AGS growth cycle type II, as disclosed in FIG. 4, can be considered as another practical simplification of the asymmetrical AGS growth cycle type I: during every step or phase in the asymmetrical cycle type II, the position of the valves 3AB, 3BC and 3AC remains unchanged, and therefore these valves can be either replaced by a hydraulic opening (3AB and 3BC) or omitted (3AC) from the setting of the plant. The succession of main phases and intermediate phases will now be continuously repeated, with a new sequence of compartments linking the influent and the effluent, using the same steps (a) to (f). This allows initially to grow, select and mature the AGS, i.e. until all flocculent sludge is converted and/or until the AGs have reached an optimum size. Later on, continuous running AGS growth cycles will allow to maintain the metabolizing capacity of the AGS over time.

As represented in FIG. 5 (reference numbers of FIG. 1 have not been transposed to FIG. 5 for clarity purpose, but should be considered), influent is pumped into compartment A by influent feeding means 4 in a first main phase MP1. After the anaerobic feeding phase, the influent-activated sludge mixture is flowing from compartment A and B to compartment C, where the biomass is separated from the treated effluent by gravitational sedimentation, by flotation or by any other method. The treated effluent or supernatant of compartment C is finally discharged via effluent weir 16C through the effluent pipe 6C with open valve 7C. Excess biomass may be discharged from compartment C by an excess sludge evacuation pipe 8 which connects to a sludge pump 9. The hydraulic connection 2AC between compartment A and C is closed. All other hydraulic interconnections 2AB and 2BC are open. This phase is controlled by the different methods mentioned above and also by the sensor unit 15 which detect.

Next, the intermediate phase IP1 consist of preparing compartment B for sedimentation. During the preparation of compartment B as new sedimentation tank, the influent is directed to compartment A by influent feeding means 4, and the influent-activated sludge mixture is transported from compartment A towards compartment C. The effluent continues to be discharged from compartment C by effluent weir 16C and the excess biosolids can be removed via an excess sludge evacuation pipe 8 which connects to a sludge pump 9. The hydraulic connections 2AB and 2BC respectively between compartments A and B and compartments B and C are closed, while the hydraulic connections 2AC between compartments A and C are open.

In phase MP2, the influent is directed into compartment C by influent feeding means 4. The—influent—activated sludge mixture is transported via compartment C and compartment A, towards compartment B. Compartment B is now functioning as sedimentation tank where the biomass is separated from the treated effluent under gravitational sedimentation, by flotation or by any other method. Effluent is discharged from compartment B by effluent weir 16B and excess biosolids are removed via the excess sludge evacuation pipe 8 which connects to a sludge pump 9. The interconnection 2BC between compartment B and C is closed. All other interconnections 2AC and 2BC are open. This phase is controlled by the different methods mentioned above and also by the sensor unit 15.

The phase IP2 consist of preparing compartment A for sedimentation. During the preparation of compartment A as new sedimentation tank, the influent is directed to compartment C by influent feeding 4. The influent-activated sludge mixture is transported from compartment C towards compartment B. The effluent continues to be discharged from compartment B by effluent weir 16B and the excess biosolids can be removed via the excess sludge evacuation pipe 8 which connects to a sludge pump 9. Only the hydraulic connection 2BC between compartment B and C is open.

In the phase MP3, influent is now directed into compartment B by influent feeding 4. The—influent—activated sludge mixture is flowing via compartment B and compartment C towards compartment A, where now the biomass is separated from the treated effluent by gravitational sedimentation, by flotation or by any other method, and effluent is finally discharged by effluent weir 16A through the effluent pipe 6A with open valve 7A. Excess bio solids are discharged by the excess sludge evacuation pipe 8 which connects to a sludge pump 9. The interconnection 2AB between compartment A and B is closed. All other interconnections 2AC and 2BC are open. This phase is controlled by the different methods mentioned above and also by the sensor unit 15.

The phase IP3 consist of preparing compartment C for sedimentation. During the preparation of compartment C as new sedimentation tank, the influent is directed to compartment B by influent feeding means 4, and the influent-activated sludge mixture is transported from compartment B towards compartment A. The hydraulic connections 2BC and 2AC respectively between compartment B and C and between C and A are closed. The effluent continues to be discharged from compartment A by effluent weir 16A. Also, excess bio solids can be discharged from compartment A by the excess sludge evacuation pipe 8 which connects to a sludge pump 9. And these phases repeat themselves indefinitely.

Alternatively, FIG. 6 (reference numbers of FIG. 1 have not been transposed to FIG. 6 for clarity purpose, but should be considered) represents a similar succession of main phases and intermediate phases in the case of an asymmetrical cycle type I. In this setting, compartment B is never a sedimentation compartment, there are therefore only two types of main phases and two types of intermediate phases (in the case of a three compartments reactor) alternating continuously. The regeneration of the compartment A occurs online by receiving the influent-activated sludge mixture from compartment B and transferring it to sedimentation compartment C (main phase 1). Vice versa, the regeneration of the compartment C occurs online by receiving the influent-activated sludge mixture from compartment B and transferring it to sedimentation compartment A (main phase 2).

Alternatively, FIG. 7 (reference numbers of FIG. 1 have not been transposed to FIG. 7 for clarity purpose but should be considered) represents a similar succession of main phases and intermediate phases in the case of an asymmetrical cycle type II. In this setting, compartment B is never a sedimentation compartment, there are therefore only two types of main phases and two types of intermediate phases (in the case of a three compartments reactor) alternating continuously. The regeneration of the compartments A and C occurs offline. When compartment B receives the influent, the influent-activated sludge mixture is transferred to either sedimentation compartment A or C.

The process was run during several weeks in the symmetrical setting, approximately 20 weeks. The experiment was run during a first period at a low capacity of 60 L of reactor volume (Period I during about 11 weeks) and later increased to 120 L (Period II during about 9 weeks). This increase of reactor volume was done in order to increase the water level and subsequently to increase the oxygen transfer efficiency and avoid excessive turbulence during anaerobic mixed feeding. The active volume must be understood as the biological active time fraction of the total reactor volume.

The duration of the intermediate phase, i.e. the preparation/sedimentation phase, was shortened in order to apply an additional hydraulic selection pressure for fast settling sludge, on top of the metabolic selection pressure for granule forming organisms. The increase of the MP/IP ratio had also a positive impact on the active volume/total volume ratio. An overview of the resulting active volumes per phase are given below:

| | | | Total | |
|---|---|---|---|---|
| | | | reactor | Active |
| | MP | IP | volume | volume |
| | (min) | (min) | (L) | (L) |
| Period I, | 120 | 30 | 60 | 36.0 |
| stage 1 | | | | |
| Period I, | 120 | 30 | 60 | 36.0 |
| stage 2 | | | | |
| Period I, | 120 | 20 | 60 | 37.1 |
| stage 3 | | | | |
| Period II, | 120 | 20 | 120 | 74.3 |
| stage 4 | | | | |
| Period II, | 120 | 15 | 120 | 75.6 |
| stage 5 | | | | |

It can be understood that a cycle of main phase plus intermediate phase takes about 150 min to 135 min. There can therefore easily be around 70 rotations of settings of the treatment plant per week.

The influent composition and the produced effluent per compartment was analyzed on a weekly basis. The effluent sample for analysis was taken from the top of the sedimentation compartment, i.e. the supernatant from the discharging compartment (50 mL), after approximately 1 hour of discharging. Before determining the influent and effluent composition, part of the sample is filtered using Whatmann™ glass microfibre filters (pore size: 0.6 μm). The target values are monitored over time.

For example, as shown on FIG. 10, CODt (dark grey) and CODs (light grey) values are monitored over 20 weeks. Samples from the supernatant of the settling compartment have been taken, to reflect the quality of effluent water. The horizontal dotted line represents the target value below which the plant should run. After about 12 weeks, this target value is stably reached. The weekly average is represented.

FIG. 11 illustrates the weekly evolution of the TP (light grey) and TN (dark grey) levels in the effluent water, as measured from the same samples as for CODt and CODs measures shown in FIG. 10. There as well, the target values are constantly met after about 12 weeks.

FIG. 12 illustrates the weekly average MLSS concentration. During Period I of the experiment, a gradual decrease of the MLSS concentration was observed due to washout of sludge not able to settle efficiently. In week 12, the total reactor volume was increased from 60 L to 120 L only by feeding without discharging, resulting in the dilution of the sludge concentration down to approximately 5 g/L. Thereafter, during Period II, the sludge concentration increased gradually towards 8 g/L, which is the target value of the experiment. A sludge concentration higher than 5 g/L is typically not applied in a standard SBR system merely due to the lower sludge settleability, limiting sludge retention inside the reactor during discharge. Being able to maintain a higher sludge concentration leads to a better efficiency and a lower footprint.

The sludge settling characteristics were evaluated through determination of the diluted SVI after 10 (dSVI₁₀) and 30 (dSVI₃₀) minutes, as shown in FIG. 13. Instead of the regular SVI determination, the diluted SVI was measured in order to avoid hindered settling due to increasing sludge concentrations. Therefore, the sludge grab sample, taken during aerobic regeneration, was diluted using effluent from the same reactor. From week 11, worsening of the sludge settling characteristics stopped. Afterwards, the dSVI₁₀ and dSVI₃₀ values gradually decreased even to a point where dSVI₁₀ were slightly below 100 ml/g (week 19-20). As presented in the above table, the intermediate phase was shortened from 30 to 20 minutes in week 6 and subsequently to 15 minutes in week 16. From our results, it is shown that shortening of the intermediate phase by 10 minutes in week 6 had no impact on the sludge settleability.

FIG. 14 illustrates the evolution of the AGS morphology from the flocculent seed sludge, magnified 40×, at weeks 1, 4, 8, 12, 16 and 20. It clearly appears that denser and bigger sludge particles are formed along with time.

Preferably, the relevant parameters are monitored using sensors placed within the compartments.

Though in the above example manual sampling and laboratory analyses have been performed, it is the intention to automate the process. A centralized computer system can convert parameters monitored using sensors placed within the compartments into suitable information to determine the status of the steps in each compartment. An algorithm can then determine or adapt continuously the main phase and intermediate phase duration. This allows to optimize the process efficiency and subsequently the performance of water treatment.

The above example relates to the conversion of the wastewater treatment unit of a brewery, which served as model. However, the invention is not limited to this setting is intended to be applicable to any continuous flow cyclic-operating system, for any type of wastewater treatment, be it industrial, urban or of any other type.

1. Process for wastewater treatment within a continuous flow cyclic-operating water treatment plant (1) comprising a series of at least three compartments, comprising sludge, in hydraulic connection (2AB, 2AC, 2BC) with each other, the process comprising:
growing, selecting and/or maintaining aerobic granular sludge in at least one compartment of the plant, while
treating water; wherein growing, selecting and/or maintaining aerobic granular sludge while treating water comprises, in the following order:
(a) continuously receiving influent water (4) into a first compartment of the series of at least three compartments where it is dispersed into the supernatant under anaerobic conditions without mixing with the sludge,
(b) continuously receiving influent water (4) into a first compartment where it is mixed with the sludge while keeping the water and sludge mixture under anaerobic conditions to promote anaerobic conversion of carbon into storage polymers to create sludge particles;
(c) passing the accumulated water and sludge mixture to the current second compartment of the series of compartments where aeration is introduced to create a dissolved oxygen gradient inside the sludge, and promote microbiological respiration;
(d) passing the water and sludge mixture to said current last compartment of the series of compartments where sludge is continuously separated by gravity from the supernatant,
(e) continuously discharging effluent from the current last compartment,
(f) preparing a compartment of the series of compartments to become a new last compartment for separation of sludge and supernatant in a new cycle of operation, by temporarily stopping circulation in, to and from this compartment, while discharging the effluent from the current last compartment, and receiving the influent water into another compartment while the water and sludge mixture is being passed from the compartment receiving the influent water towards said current last compartment to provide continuous flow of effluent,
and, in subsequent cycle of operation:
(g) repeating main phase steps (a) to (e) and the intermediate phase step (f) in the new operating cycle, whereby all compartments of the first cycle become a series of hydraulically linked compartments in the new cycle with the new last compartment of step (f) being used for separation of sludge and effluent,
(h) repeating step (g) to rotate the cyclic operation of the compartments to obtain, select and/or maintain AGS.

2. Process according to claim 1, wherein step (a) is a non-mixed anaerobic feeding step.

3. Process according to claim 1 or 2, wherein, in step (c), introducing aeration into the water and sludge mixture to create a dissolved oxygen gradient inside the sludge, and promote microbiological respiration preferably occur within at least the second compartment of the series.

4. Process according to one of claims 1 to 3, wherein starting step (f) comprises acting upon some means to open or close the inlets (4), outlets (6) and hydraulic connection (2AC, 2AB, 2 BC) between the compartments.

5. Process according to one of claims 1 to 4, which is fully automated to dynamically control the duration of at least one main phase of steps (a) to (e)) and/or intermediate phase of step (f).

6. Process according to one of claims 1 to 5, further comprising monitoring parameters in each compartment in order to extract information related to the status of the biological process and/or the settling process and determining or adjusting, depending on these statuses, the duration of steps (a) to (e).

7. Continuous flow cyclic-operating water treatment plant (1) comprising a series of at least three compartments with hydraulic connections (2AC, 2AB, 2 BC) between each other, the plant comprising:
water inlet (4) means arranged at the top of the compartments equipped with valves (5A, 5B, 5C);
weirs (16A, 16B, 16C) arranged towards the top of the compartments for discharging effluent;
hydraulic connections (2AC, 2AB, 2 BC) between the compartments, preferably located towards the bottom or at the bottom of the compartments;
mixing means within the compartments;
aeration means within the compartments;
means to measure parameters within the compartments;
a driving unit for receiving and analyzing the parameters measured within the reactor, and, in function of the output of this analysis, manage the water inlet (4), the discharge of clean water through the weirs (16A, 16B, 16C), the mixing means, the aeration means and/or the hydraulic connections (2AB, 2 AC, 2BC) between the compartments.

8. Water treatment plant (1), according to claim 7, further comprising means (like valves 3AB, 3AB, 3BC) to open or close the hydraulic connections (2AC, 2AB, 2 BC).

9. Water treatment plant (1), according to claim 7 or 8, wherein all compartments are provided with the same equipment.

10. Water treatment plant (1), according to one of claims 7 to 9, wherein the driving unit is a CPU within a computer system or server in which a program is installed, which, when run, can receive the information from the means to measure parameters and send information and/or orders to the valves (3AB, 3AB, 3BC), the means to open or close the hydraulic connections (2AC, 2AB, 2 BC), the mixing means and/or the aeration means of the compartments.

11. Water treatment plant (1), according to one of claims 7 to 10, wherein the means to measure parameters within the compartments are sensors.

12. Water treatment plant (1), according to claim 11, wherein the sensors unit (15A, 15B, 15C) comprise at least one of MLSS sensors, flowmeters, thermometers, DO sensors, pH sensors, redox sensors, conductivity sensors, turbidity sensors and/or ammonium nitrates and/or phosphate sensors.

13. Water treatment plant (1), according to one of claims 7 to 12, further comprising means (8, 9) to remove the excess sludge from the compartments.
